(19) United States
(12) Patent Application Publication
(10) Pub. No.: US 2004/0136885 A1
(43) Pub. Date: Jul. 15, 2004

(54) Apparatus and method for generating ozone

(76) Inventors: Derek J. Hogarth, Portland, OR (US); Jun Fu, Port Coquitlam (CA)

Correspondence Address: Ralph A. Dowell, Dowell & Dowell, P.C., Suite 309, 1215 Jefferson Davis Hwy., Arlington, VA, 22202, US

(21) Appl. No.: 10/338,693

(22) Filed: Jan. 9, 2003

(51) Int. Cl. B01J 19/08; B01J 19/12

(52) U.S. Cl. 422/186.07; 422/186.18

(57) ABSTRACT

An ozone generation apparatus and method is described. The apparatus includes a dielectric body having a wall defining a fluid passageway operable to contain and conduct fluid containing oxygen, a first conductor generally having a line geometry extending lengthwise in the passageway and a second conductor generally having a line geometry, supported outside of the passageway by the body to extend generally parallel to the first conductor. The first and second conductors are arranged to cause an electric field to be established therebetween and through the fluid passageway when an electric potential is applied across the first and second conductors.

### BACKGROUND OF THE INVENTION

1. Field of Invention This invention relates to ozone generators and more particularly to ozone generators employing conductors having a line geometry.

2. Description of Related Art

Generally ozone generation cells employ two spaced apart electrodes with a gap in between, in which an electric field is formed with sufficient strength to ionize a fluid such as air in the gap. The electric field has sufficient strength to ionize air when it is able to accelerate electrons released from the surface of one of the electrodes or a dielectric material in the gap such that they have sufficient kinetic energy to penetrate, or punch oxygen (O₂) molecules in the fluid in the gap causing them to split into two ions (O+) which readily combine with O₂ to create one ozone (O₃) molecule.

Not all electrons actually hit an O₂ molecule. Some electrons hit nitrogen (N₂) or other molecules in the gap and release their kinetic energy to those molecules as heat, optical or ultraviolet energy. Other electrons never hit any molecules in the gap, rather, they release their kinetic energy as heat, optical or ultraviolet energy when they hit the opposite electrode. Furthermore, not all electrons are released from the surfaces of electrodes or dielectrics with the same ease.

Desirably, the electric field created in the gap is configured to impart enough electrons with sufficient kinetic energy to punch O₂ molecules and desirably the gap is suitably dimensioned to expose released electrons to a sufficiently large number of O₂ molecules such that the probability that an electron will punch an O₂ molecule is maximized.

The kinetic energy imparted to electrons and thus the ability to ionize O₂ is highly dependent upon the electric field in the gap and on the ability of the surfaces defining the gap to release electrons. The electric field depends upon the potential applied to the electrodes, but once this potential is set, the electric field at any given point in the gap is affected by non-uniformities in the spacing between the electrodes, non-uniformities in the thickness of any dielectric material in the gap, lack of smoothness of discharge surfaces on the electrodes, and non-uniform airflow in the gap. These non-uniformities create localized changes in the electric field and affect the kinetic energy imparted to electrons in certain areas of the gap. Consequently, insufficient kinetic energy to ionize O₂ may be imparted to electrons in some areas and more kinetic energy than is required to ionize O₂ may be imparted to electrons in other areas.

In general, any electrons that do not punch an O₂ molecule to produce ions that ultimately become O₃ release their kinetic energy as optical energy, ultraviolet energy, or as heat either to the molecules in the gap, to the electrode to which the electrons are attracted or to the dielectric within the gap. The heat energy produced from the kinetic energy of the non-ozone producing electrons heats up the fluid in the gap. Beyond a certain temperature, ozone production is diminished.

In areas where the kinetic energy imparted to electrons is optimum a localized ion cloud area may be formed which readily provides ions to incoming fluid in the gap. In areas where the kinetic energy is not used to create ions, localized non-ionization areas are formed, in which ozone production is not optimized.

What would be desirable therefore is a way of maximizing ion cloud areas within the gap while minimizing non-ion cloud areas to optimize ozone production, or in other words, to produce ozone in the highest concentration with minimal expenditure of energy.

### SUMMARY OF THE INVENTION

In accordance with one aspect of the invention there is provided an ozone generation apparatus comprising a dielectric body having a wall defining a fluid passageway operable to contain and conduct fluid containing oxygen, a first conductor generally having a line geometry extending lengthwise in the passageway and a second conductor generally having a line geometry, supported outside of the passageway by the body to extend generally parallel to the first conductor. The first and second conductors are arranged to cause an electric field to be established therebetween and through the fluid passageway when an electric potential is applied across the first and second conductors.

The dielectric body may have first and second generally parallel flat planar opposing surfaces on opposite sides of the fluid passageway and the second conductor may be on one of these surfaces.

The wall may be cylindrical or oval, for example.

The first and second conductors may have generally circular cross sections or generally rectangular cross sections, or may have other cross sectional shapes.

At least one of the first and second conductors may have a generally circular cross section and/or at least one of the first and second conductors may have a rectangular cross section. A conductor having a rectangular cross-section may be provided by a metallized film coating.

In one embodiment, the body comprises first and second sections. The first conductor is on the first section and the second conductor is on the second section.

The first section may have a first wall section defining a groove lengthwise therein and the first conductor may be disposed lengthwise along the first wall section, in the groove.

The second section may have a second wall section defining a mating groove extending lengthwise therein and the first and second sections may be joined together such that the first and second grooves define the fluid passageway. The fluid passageway may be generally symmetrical.

The dielectric body may include a tube having interior and exterior walls and the first conductor may extend lengthwise along the interior wall in the tube while the second conductor extends lengthwise along the exterior wall of the tube.

One of the first and second conductors may be covered with an insulating material such as epoxy resin.

The tube may have a helical shape. The second conductor may follow the helical shape in a groove formed between adjacent coils of the tube in the helical shape.

In accordance with another aspect of the invention, there is provided a method of generating ozone. The method involves establishing an electric field between first and second line conductors, at least one of which is in a passageway defined in a dielectric body and the other of which is outside of said passageway such that the first and second line conductors are generally parallel and generally uniformly spaced apart, the electric field having sufficient strength to ionize oxygen in the passageway.

In general, the passageway formed in the dielectric material has a cross-sectional shape that generally corresponds to the shape an electric field created between two line electrodes about the passageway, where one of the electrodes is in the passageway.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a schematic representation of an ozone generation apparatus according to a first embodiment of the invention,

FIG. 2 is a schematic representation of an ozone generation apparatus according to a second embodiment of the invention,

FIG. 3 is a schematic representation of an ozone generation apparatus according to a third embodiment of the invention,

FIG. 4 is a schematic representation of an ozone generation apparatus according to a fourth embodiment of the invention,

FIG. 5 is a schematic representation of an ozone generation apparatus according to a fifth embodiment of the invention,

FIG. 6 is a schematic representation of an ozone generation apparatus according to a sixth embodiment of the invention,

FIG. 7 is a schematic representation of an ozone generation apparatus according to a seventh embodiment of the invention,

FIG. 8 is a schematic representation of an ozone generation apparatus according to an eighth embodiment of the invention, and

FIG. 9 is a schematic representation of an ozone generation apparatus according to a ninth embodiment of the invention.

### DETAILED DESCRIPTION

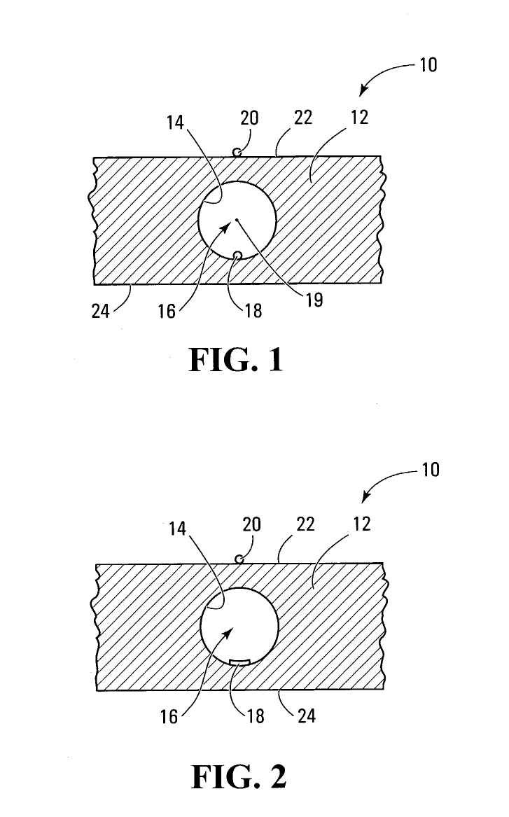

Referring to FIG. 1, an ozone generation apparatus according to a first embodiment of the invention is shown generally at 10. The apparatus includes a dielectric body 12 made of glass, Teflon®, polyethylene or poly propylene, for example, having a cylindrically shaped wall 14 defining a relatively symmetrical fluid passageway 16 operable to contain and conduct fluid containing oxygen. The apparatus further includes a first conductor 18 generally having a line geometry and extending lengthwise parallel to an axis 19 of the fluid passageway. By “line geometry”, it is meant that the length of the first conductor 18 is very much longer than its width. For example, a wire is considered to have a line geometry within this definition, and in fact a wire may be used as the first conductor 18.

The first conductor 18 extends in the fluid passageway 16 and along the wall 14. The first conductor 18 may be held in place by casting it in the dielectric body 12 or by holding it in place with an adhesive. Alternatively, the first conductor may be formed on a film or tape having an adhesive and the film or tape may be laid along the inside wall 14 of the fluid passageway 16 to secure it to the dielectric body 12.

The apparatus further includes a second conductor 20 also generally having a line geometry, supported outside of the passageway 16 by the body 12 to extend generally parallel to the first conductor 18. The first and second conductors 18 and 20 are arranged to cause an electric field to be established between them and through the fluid passageway 16 when an electric potential is applied across the first and second conductors, such that the electric field is operable to ionize oxygen (O₂) in fluid in the fluid passageway.

In the embodiment shown in FIG. 1, the dielectric body 12 has first and second generally parallel flat planar opposing surfaces 22 and 24 on opposite sides of the fluid passageway 16 and the second conductor 20 extends along the first surface 22 causing it to be generally parallel and uniformly spaced apart from the first conductor 18. The second conductor 20 is held in place by any of the methods described above for holding the first conductor 18 in place. In the embodiment shown, both the first and second conductors 18 and 20 have a generally circular cross-section although in other embodiments such as shown in FIG. 2, the first conductor 18 may have a rectangular cross section while the second conductor has a generally circular cross section, or vice versa. Other cross sectional shapes could also be used such as an oval shape, half-disk shape, gently concave thick arcuate shape, tightly curved C shape, gently curved thin arcuate shape, square rectangular shape, and elongated rectangular shape, for example. The actual cross-sectional shape of the first and second conductors is not critical and becomes less important as the cross-sectional area of the first and second conductors 18 and 20 is decreased. The shape may be selected as a matter of convenience and may be determined by the manufacturing process used to form the first and second conductors 18 and 20.

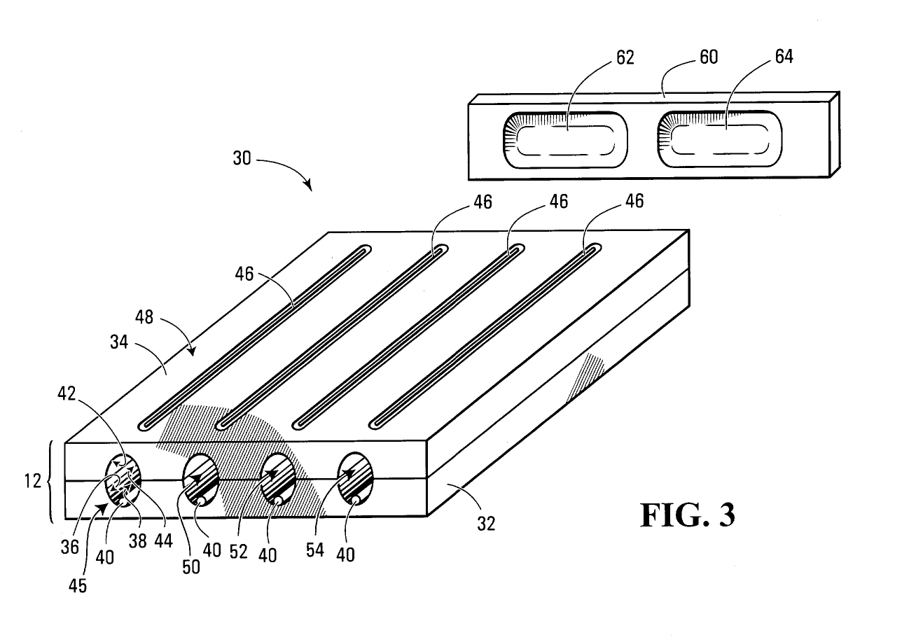

Referring to FIG. 3, an ozone generator according to an alternative embodiment of the invention is shown generally at 30. In this embodiment, the dielectric body 12 comprises first and second generally planar sections 32 and 34. The first section 32 has a first wall section 36 defining a groove 38 extending lengthwise therein. A first conductor 40 is disposed lengthwise along the first wall section 36, along a lower portion of the groove 38. The second section 34 has a second wall section 42 defining a mating groove 44 extending lengthwise therein. The first and second sections 32 and 34 are joined together such that the first and second grooves 38 and 44 define a fluid passageway 45 operable to contain and conduct fluid such as air containing oxygen. A second conductor 46 generally having a line geometry is formed on an outer surface 48 of the second planar section 34 to extend parallel to the second groove 44, adjacent a lower portion thereof, such that when the first and second sections 32 and 34 are joined together as shown, the first and second conductors 40 and 46 are generally parallel and uniformly spaced apart. An electric potential may be applied across the first and second conductors 40 and 46 to establish an electric field within the passageway 45 formed by first and second grooves 38 and 44 with the electric potential having sufficient strength to ionize air within the passageway to produce ozone. As seen in FIG. 3 the first and second sections 32 and 34 may be of sufficient dimensions to have a plurality of parallel grooves to be formed therein to form a plurality of passageways 45, 50, 52, 54, each with a respective first and second conductor 40 and 46. Each of the first conductors 40 may be electrically connected together, in parallel, while each of the second conductors 46 may also be electrically connected together in parallel to form a plurality of areas in the body 12, that can be used to make ozone. The passageways 45, 50, 52 and 54 may be used to conduct air in a parallel fashion and end plates, one of which is shown at 60 may contain grooves such as shown at 62 and 64 for directing fluid from one groove to an adjacent groove, thereby creating a serpentine fluid flow path within the body 12, effectively forming a passageway having a length that is about the same as the sum of the lengths of each passageway 45, 50, 52 and 54. This may be useful where it is desirable to maintain the fluid exposed to the electric field for a greater length of time, thereby increasing the concentration of ozone in the fluid that exits the final passageway.

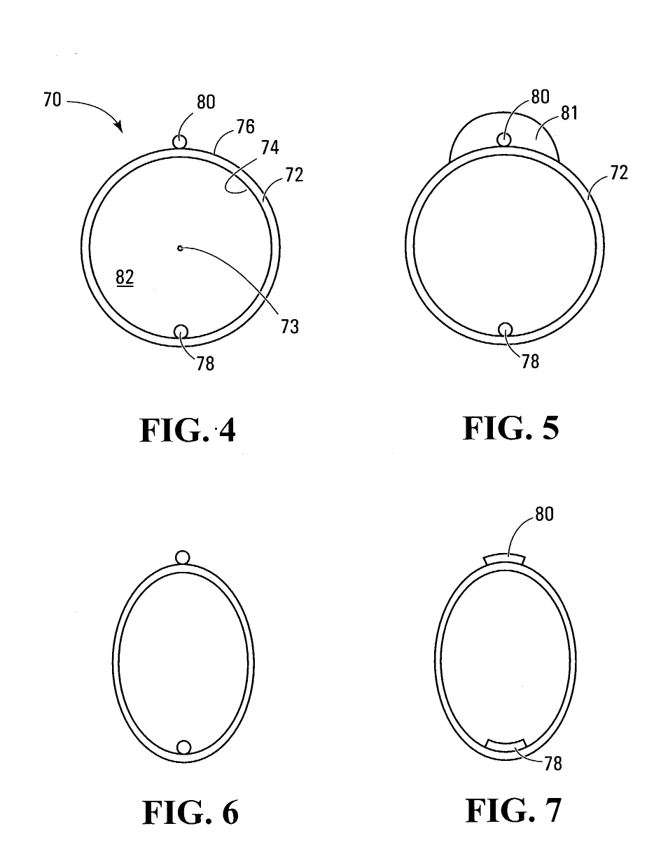

Referring to FIG. 4, an apparatus according to another alternative embodiment is shown generally at 70. In this embodiment, the dielectric body includes a circular cylindrical tube 72 having an axis 73 and interior and exterior wall surfaces 74 and 76. A first conductor 78 extends lengthwise along the interior wall surface 74 generally parallel and uniformly spaced apart from the axis 73 and a second conductor 80 having a line geometry extends lengthwise along the exterior wall surface 76 of the tube 72 parallel to the first conductor 78. The interior wall surface 74 defines a fluid passageway 82 operable to contain and conduct fluid containing oxygen through an electric field in the passageway 82 formed between the first and second conductors 78 and 80 when a potential is applied across the first and second conductors and the first and second conductors are dimensioned and arranged to support an electric field of sufficient strength to ionize 02 in the fluid passageway 82.

Referring to FIG. 5, the second conductor 80 may be covered with an insulating material such as epoxy resin 81 to help prevent electric shock to persons using the apparatus.

Alternatively, the tube may have a oval shape as shown in FIG. 6.

In another alternative embodiment, at least one of the first and second conductors 78 and 80 may have a rectangular shape such as shown in FIG. 7, in which both the first conductor and the second conductor have a rectangular cross sectional shape. These conductors may be formed as metal films on mylar tape, for example. The mylar tape may have an adhesive permitting the tape to be adhesively secured to the inner and/or outer surfaces of the dielectric material to position the first and second conductors as described.

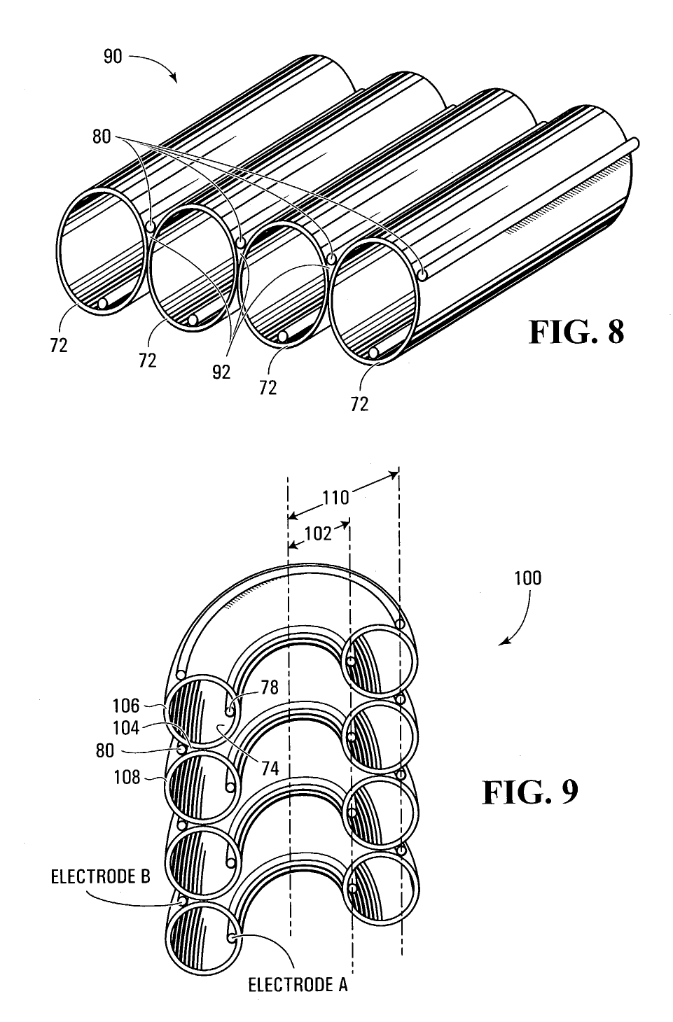

The embodiment shown in FIG. 4 may be repeated as shown in FIG. 8, by placing a plurality of the tubes 72 shown in FIG. 4 side-by-side such as shown at 90 in FIG. 8 and placing the second conductors 80 in grooves 92 formed between adjacent tubes.

Alternatively, referring to FIG. 9, the tube shown in FIG. 4 may be formed into a helical shape as shown at 100 in FIG. 9. The first conductor 78 follows the interior wall surface 74, following an inner radius of curvature 102 while the second conductor 80 follows the helical shape in a groove 104 formed between adjacent coils 106 and 108, for example, in the helical shape. The second conductor 80 thus follows an outer radius of curvature 110 which is greater than the inner radius of curvature 102.

The selection of embodiments for any application may be influenced by manufacturing techniques. The embodiment shown in FIG. 3 may be the simplest to make and hence the least expensive. The embodiment shown in FIG. 9 is also relatively easy and simple to make. Any of the embodiments shown may be submerged in coolant if cooling is desired.

A fluid such as air may be blown through the passageways formed in the dielectric bodies of the above embodiments and with the application of a suitable potential across the first and second conductors in each case, air exiting the passageway will contain ozone. Generally, the flow of air will affect the concentration of ozone in the exit air and thus ozone concentration may be optimized for any given embodiment by adjusting the air flow.

In the embodiment shown in FIGS. 1-6, the arrangement of the conductors and the line geometry of the conductors tends to cause an electric field having a shape that generally corresponds to the cross-sectional shape of the passageway to be created. Thus the electric field is optimized to the shape of the passageway. In the embodiments shown in FIGS. 8 and 9 the arrangement of the line conductors creates in the passageway an electric field that is concentrated within the passageway formed in the dielectric. As a result, ion cloud areas are maximized and hence ozone production is maximized within the passageway.

While specific embodiments of the invention have been described and illustrated, such embodiments should be considered illustrative of the invention only and not as limiting the invention as construed in accordance with the accompanying claims.

What is claimed is:

1. An ozone generation apparatus comprising:
a dielectric body having a wall defining a fluid passageway operable to contain and conduct fluid containing oxygen;
a first conductor generally having a line geometry extending lengthwise in the fluid passageway; and
a second conductor generally having a line geometry, supported outside of said passageway by said body to extend generally parallel to said first conductor, said first and second conductors being arranged to cause an electric field to be established therebetween and through the fluid passageway when an electric potential is applied across said first and second conductors.

2. The ozone generation apparatus of claim 1 wherein said wall is cylindrical.

3. The ozone generation apparatus of claim 1 wherein said dielectric body includes a tube having interior and exterior walls, said first conductor extending lengthwise along said interior wall in said tube and said second conductor extending lengthwise along said exterior wall of said tube.

4. The ozone generation apparatus of claim 3 wherein said second conductor is covered with an insulating material.

5. The ozone generation apparatus of claim 4 wherein said insulating material includes epoxy resin.

6. The ozone generation apparatus of claim 3 wherein said tube has a helical shape.

7. The ozone generation apparatus of claim 6 wherein said second conductor follows said helical shape in a groove formed between adjacent coils of said tube in said helical shape.

8. The ozone generation apparatus of claim 1 wherein said first and second conductors have generally circular cross sections.

9. The ozone generation apparatus of claim 1 wherein said first and second conductors have generally rectangular cross sections.

10. The ozone generation apparatus of claim 1 wherein said dielectric body has first and second generally parallel flat planar opposing surfaces on opposite sides of said fluid passageway and wherein said second conductor is on one of said first and second surfaces.

11. The ozone generation apparatus of claim 10 wherein at least one of said first and second conductors has a generally circular cross section and at least one of said first and second conductors has a rectangular cross section.

12. The ozone generation apparatus of claim 1 wherein said body comprises first and second sections, said first conductor being on said first section and said second conductor being on said second section.

13. The ozone generation apparatus of claim 12 wherein said first section has a first wall section defining a groove lengthwise therein, said first conductor being disposed lengthwise along said first wall section in said groove.

14. The ozone generation apparatus of claim 13 wherein said second section has a second wall section defining a mating groove extending lengthwise therein, said first and second sections being joined together such that said first and second grooves define said fluid passageway.

15. The ozone generator of claim 1 wherein said passageway is generally symmetrical.

16. An apparatus for generating ozone, the apparatus comprising:
means for defining a fluid passageway operable to contain and conduct fluid containing oxygen in a dielectric body;
means for conducting electric current generally in a first line in said passageway;
means for conducting electric current generally in a second line outside of said passageway, said first and second lines being generally parallel and generally uniformly spaced apart;
said means for conducting being operable to support an electric field between said first and second lines, in said passageway with sufficient strength to ionize oxygen in said passageway.

17. A method of generating ozone comprising:
establishing an electric field between the first and second line conductors,
at least one of said first and second line conductors being in a passageway defined in a dielectric body and the other of said first and second line conductors being outside of said passageway such that the first and second line conductors are generally parallel and generally uniformly spaced apart,
the electric field having sufficient strength to ionize oxygen in the passageway.

18. An apparatus for generating ozone, the apparatus comprising:
a tube formed of a dielectric material and having an axis and an inside surface defining a fluid passageway operable to conduct and contain a fluid containing oxygen and said tube having an outside wall surface;
a first conductor having a line geometry extending along said inside wall surface parallel to an axis of said tube;
a second conductor having a line geometry extending along said outside wall surface generally parallel and generally uniformly spaced apart from said first conductor;
wherein said tube, said first conductor and said second conductor are dimensioned and arranged to support an electric field between said first and second conductors with sufficient strength to ionize air in said passageway.

19. An apparatus as claimed in claim 18 wherein said tube has a helical shape having adjacent loops forming a helical groove therebetween and wherein said second conductor is positioned in said helical groove.
